(19) United States
(12) Patent Application Publication
(10) Pub. No.: US 2016/0077654 A1
(43) Pub. Date: Mar. 17, 2016

(54) Touch Panel-Type Operation Panel and Control Method Therefor

(71) Applicant: HITACHI, LTD., Chiyoda-ku, Tokyo (JP)

(72) Inventors: Tadaaki ISHIKAWA, Tokyo (JP); Kenichi KATONO, Tokyo (JP); Setsuo ARITA, Tokyo (JP); Masaki KANADA, Tokyo (JP); Yoshihiko ISHII, Tokyo (JP); Ryota KAMOSHIDA, Tokyo (JP)

(21) Appl. No.: 14/784,133

(22) PCT Filed: Oct. 11, 2013
(86) PCT No.: PCT/JP2013/077691

§ 371 Date: Oct. 13, 2015

(30) Foreign Application Priority Data
Apr. 15, 2013 (JP) 2013-085074

(51) Int. Cl. G06F 3/041; G06F 3/044; G06F 3/0488

(52) U.S. Cl. CPC G06F 3/0416; G06F 3/0412; G06F 3/0488; G06F 3/044; G06F 2203/04808; G06F 2203/04806

(57) ABSTRACT

To eliminate or reduce stress for an operator who operates an operation panel. A touch panel-type operation panel includes a display with touch panel including an image display surface for displaying an operation part and a control device. The display with touch panel detects approach of an operation finger to the operation part and the position of the operation part and outputs signals of the detected approach of the operation finger and the detected position. The control device predicts and analyzes, in response to an input of the signals of the approach of the operation finger and the position, a state of a control target by operation corresponding to the operation part with reference to state data of the control target, determines appropriateness of the predicted and analyzed operation, and outputs a result of the determination.

### TECHNICAL FIELD

The present invention relates to a touch panel-type operation panel and a control method therefor.

### BACKGROUND ART

In a plant or a facility entirely controlled by one person or a small number of people such as a power generation plant such as a nuclear or thermal power generation plant, a chemical plant such as a petrochemical plant, or an automatic production line, an operation panel is often used that includes a display unit that displays operating states of apparatuses, an operation situation of the plant, and the like based on operation information, apparatus response data, sensor data to enable concentrated monitoring and state check, an input unit for inputting operation for facilities and the apparatuses, and a control-signal generating unit that converts the operation input into an apparatus control signal and outputs the apparatus control signal.

In recent years, an increasing number of operation panels are configured as a touch panel display-type operation panel with which, for wrong operation prevention, to enable a more intuitive operation input, an operator performs an operation input by touching, using a display with touch panel, a part indicator that the operator desires to operate.

Further, as described in Patent Literature 1, there is a technique for, for example, predicting a position on a display unit that an operator is about to touch, changing a display color, and highlighting the position desired to be operated, or displaying another menu, further detecting approaching speed to the display unit, and changing a magnification ratio of display to prevent wrong operation and improve operability.

There has been proposed, as in Patent Literature 2, for example, a method of, for example, operating a simulator without immediately outputting a plant control signal in response to input operation on a touch panel to display a response to operation on a screen and, after an operator confirms that the operation is appropriate operation, outputting an actual control signal to limit actuation of an apparatus by wrong operation.

Both of the methods aim at a reduction in a wrong operation of the operator or a malfunction of an apparatus due to the wrong operation. However, in Patent Literature 1, the technique does not have a function of automatically stopping an output of a control signal. It is necessary to determine a contact position and change screen display at a point where the operator can stop touching a touch panel at the will of the operator, that is, a point sufficiently before a contact point. In a series of operation of “touching with a fingertip” by a normal person, the distance position described above is a position where other contact points can be selected. It is difficult to predict a contact point at this point in time. Therefore, actually, an operation of bringing the fingertip close to the contact point and, waiting for an operation panel to detect that the finger is brought close to the contact point and switching to display corresponding thereto, touching the contact point is performed. That is stress of response delay for the operator.

In Patent Literature 2, the actual control signal is output after the operator confirms that the operation is the appropriate operation intended by the operator. Therefore, the operator performs operation of, after pressing an operation button, determining appropriateness of a display result and pressing a confirmation button. The operator needs to perform work twice for one operation. Stress of poor responsiveness is given to the operator. This causes new wrong operation, for example, the operator is not patient enough for the end of the operation and performs the next operation. Although there is an advantage that a simulation is performed on the basis of the latest plant data, actually, after the simulation, a waiting time until a confirmation input of appropriateness by the operator is necessary before the output of the control signal. The advantage is lost by the time lag.

### CITATION LIST

### Patent Literature

PTL 1: JP-A-2001-14024
PTL 2: JP-A-5-143292

### SUMMARY OF INVENTION

### Technical Problem

In the method of suppressing wrong operation of the operation panel by the operator, work is necessary in time for waiting for output display and useless time for a confirmation input for operation. The operator feels this as a temporal delay and feels stress. In particular, under a situation in which the operator has no spare time and is forced under tension, for example, at emergency time, this causes new wrong operation.

### Solution to Problem

A touch panel-type operation panel disclosed herein includes: a display with touch panel including an image display surface for displaying an operation part; and a control device. The display with touch panel detects approach of an operation finger to the operation part and the position of the operation part and outputs signals of the detected approach of the operation finger and the detected position. The control device predicts and analyzes, in response to an input of the signals of the approach of the operation finger and the position, a state of a control target by operation corresponding to the operation part with reference to state data of the control target, determines appropriateness of the predicted and analyzed operation, and outputs a result of the determination.

### Advantageous Effect of Invention

According to the present invention, it is possible to eliminate or reduce stress for an operator who operates an operation panel.

### BRIEF DESCRIPTION OF THE DRAWINGS

FIG. 1 is a schematic diagram showing an operation panel for operating a plant.

FIG. 2 is a side view showing an example of an operation part indicator on a touch panel.

FIG. 3 is a schematic diagram showing another configuration example of a display with touch panel.

FIG. 4 is a schematic diagram showing another operation panel for operating a plant.

FIG. 5 is a schematic diagram showing still another configuration example of the display with touch panel.

### DESCRIPTION OF EMBODIMENTS

Embodiments of the present invention are explained below.

### First Embodiment

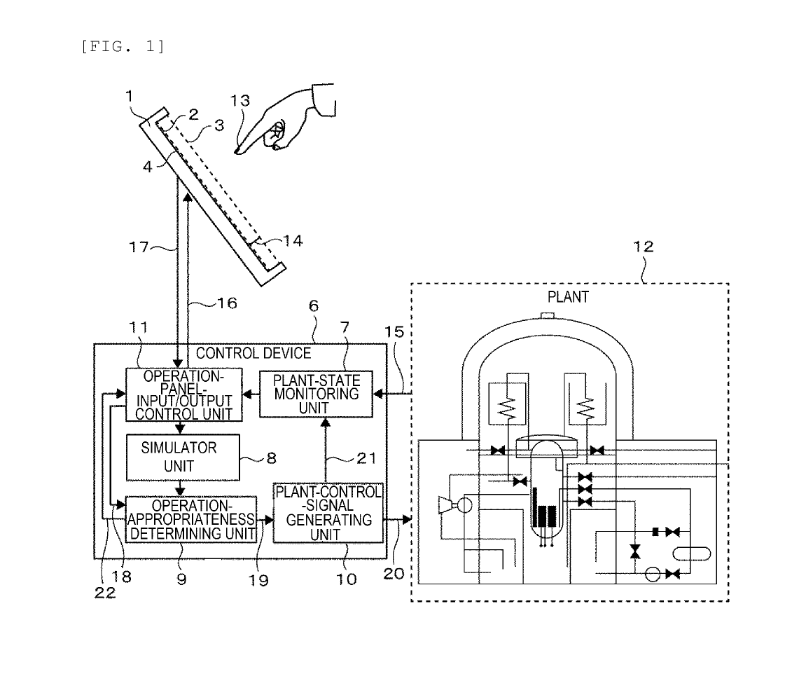

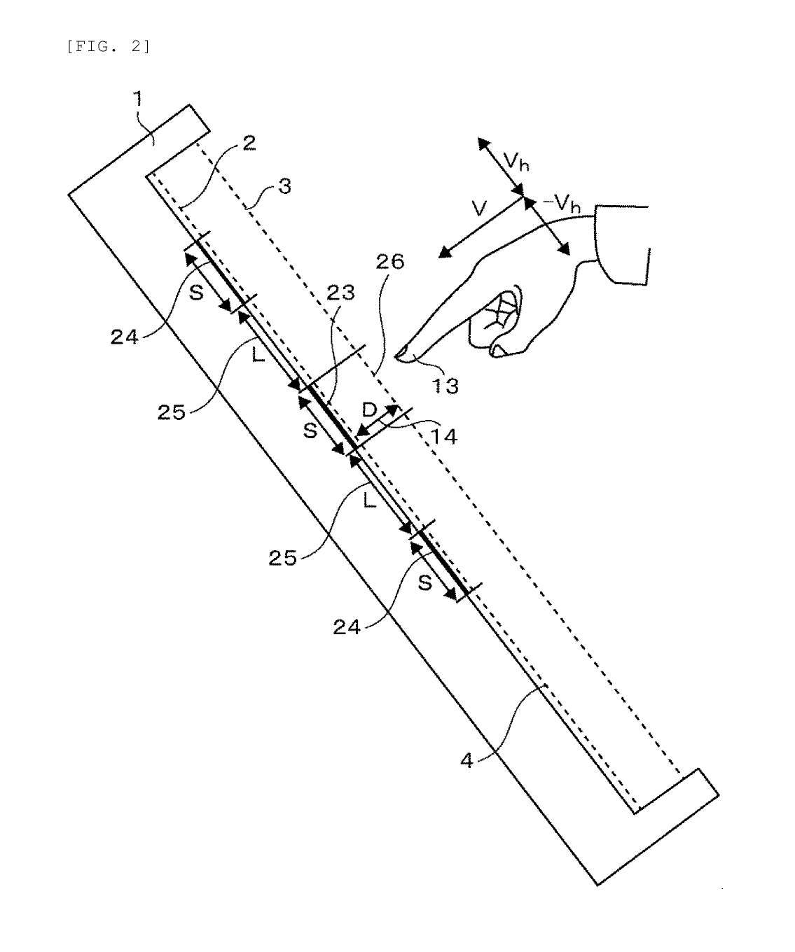

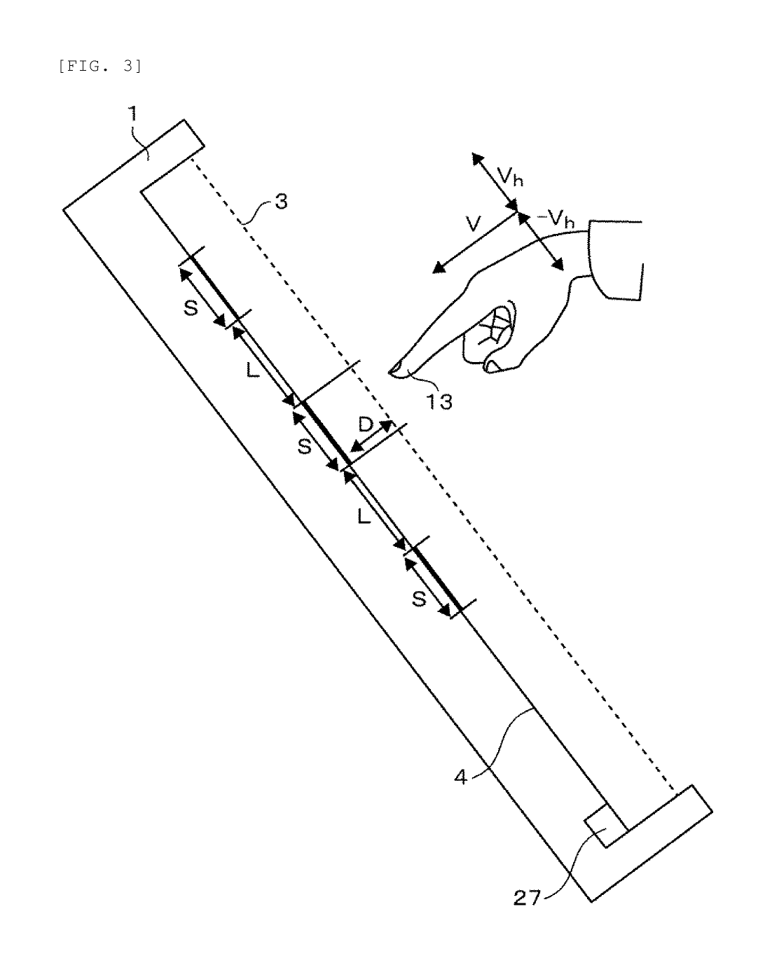

FIG. 1 is a schematic diagram showing an operation panel for operating a plant. FIG. 2 is a side view showing a positional relation of operation part indicators on a touch panel. FIG. 3 is a schematic diagram showing another configuration example of a display with touch panel.

In FIG. 1, a display with touch panel 1 includes an image display surface 4, a first detection surface 2 contiguous to an operator side of the image display surface 4, and a second detection surface 3 apart from the first detection surface by a predetermined distance in the normal direction. The display with touch panel 1 is a display device that displays information necessary for the operation of a plant 12, which is a control target, and is an input device for instructing issuance of a control signal. State data 15 of the plant including environmental information is input to a plant-state monitoring unit 7 in a control device 6 and converted into, by an operation-panel-input/output control unit 11, display image data 16 including an operation part indicator serving as a contact target for the operator to input commands for screen operation, plant control, and the like. The display image data 16 is presented to the operator from the touch panel display 1. The plant-state monitoring unit 7 diagnoses a state of the plant 12 on the basis of the state data 15. When determining that the state of the plant 12 is abnormal, the plant-state monitoring unit 7 emits a warning or an alarm. The state of the plant and the warning or the alarm are displayed on the touch panel display 1 according to the same procedure.

When the operator is about to touch an operation part indicator indicating control operation on the touch panel display 1 in order to control the plant, first, a fingertip 13 (an operation finger) of the operator is detected on the second detection surface 3, a position in the surface is specified, and the specified position is output to the operation-panel-input/output control unit 11 as a signal 17. Subsequently, the fingertip 13 of the operator is detected on the first detection surface 2 on the image display surface 4. The detection or a position of the detection is output to the operation-panel-input/output unit 11 as the signal 17.

At a point in time when the position signal on the second detection surface 3 is input, the operation-panel-input/output control unit 11 determines, from comparison of input position information and position information of the operation part indicator, operation that the operator is about to perform. The operation-panel-input/output control unit 11 outputs a determination result to a simulator unit 8 as prediction data of operation together with the latest plant state data at that point in time. The simulator unit 8 performs a prediction analysis on the basis of the prediction data of operation and the plant state data and outputs an analysis result to an operation-appropriateness determining unit 9. The operation-appropriateness determining unit 9 determines, from the input analysis result, according to a determination standard set in advance, whether the operation that the operator is about to perform is appropriate.

When determining that the operation is appropriate, after confirming an input via the operation-panel-input/output control unit 11 of a signal 18 indicating that the fingertip 13 of the operator is detected on the first detection surface 2, the operation-appropriateness determining unit 9 outputs, to a plant-control-signal generating unit 10, a request signal 19 for causing the plant-control-signal generating unit 10 to generate a plant control signal corresponding to the operation that the operator is about to perform. The plant-control-signal generating unit 10, to which the request signal 19 is input, generates a plant control signal 20 corresponding to the request signal 19, outputs the generated plant control signal 20 to the plant 12, and outputs, to the plant-state monitoring unit 7, a communication signal 21 indicating that the plant control signal 20 is output to the plant 12. Since the plant control signal 20 is a specific signal for causing apparatuses in the plant 12 to operate, the plant control signal 20 is not always a single signal and is sometimes a collection of signals for a plurality of apparatuses of facilities. The plant-state monitoring unit 7, to which the communication signal 21 is input, uses the communication signal 21 to check whether the plant 11 operates as operated by the operator and the state data 15 changes.

When determining that the prediction analysis result for the operation by the simulator unit 8 is not appropriate, the operation-appropriateness determining unit 9 outputs an operation rejection signal 22 to the operation-panel-input/output control unit 11 and causes the operation-panel-input/output control unit 11 to take measures for stopping effectiveness of the part indicator concerning the operation that the operator is about to perform. Even if the signal 18 indicating that the fingertip 13 of the operator is detected on the first detection surface 2 is input to the operation-appropriateness determining unit 9, the operation-appropriateness determining unit 9 does not output the request signal 19 for causing the plant-control-signal generating unit 10 to generate the plant control signal. According to the operation of the operation-appropriateness determining unit 9, it is possible to prevent wrong operation and inappropriate operation of the operator.

The units of the control device 6 do not need to be individually present independently from one another in terms of hardware or software. The functions of the units only have to be present in one or more kinds of software.

It is when the fingertip 13 physically comes into contact with an object that the operator feels that the operator actually performs operation. In this embodiment, if the image display surface 4 or the first detection surface 2 is a contact-type touch panel, the operator feels that the operator actually performs operation when the fingertip 13 comes into contact with the detection surface 2. On the other hand, the prediction analysis by the simulator unit 8 has already been started when the fingertip 13 passes through the second detection surface 3. The determination by the operation-appropriateness determining unit 9 has already ended before the fingertip 13 reaches the first detection surface 2. Therefore, a waiting time from the time when the operator feels that the operator performs operation until propriety of the operation (continuation or stop of display of effectiveness of apart indicator concerning the operation) is output is shorter and the operator feels less stress than when the simulator unit 8 starts the prediction analysis after the fingertip 13 actually comes into contact with the first detection surface 2.

A relation among the distance between operation part indicators adjacent to each other and the distance between the first detection surface 2 and the second detection surface 3, speed at which the operator causes the fingertip 13 to approach, a grace time that can be used for processing such as the prediction analysis by the simulator unit 8, and the like is explained with reference to FIG. 2. For simplification, FIG. 2 is a side view. Operation part indicator intervals in the up-down direction on the image display surface are focused on and explained. However, the same applies in the left-right direction.

In FIG. 2, a plurality of operation part indicators set as targets in the case of contact of the fingertip 13 are present on the image display surface 4. The operator is about to touch an operation part indicator 23 at speed V. On the second detection surface 3, for the fingertip 13 to be detected as being about to come into contact with the operation part indicator 23 set as the target, the fingertip 13 needs to pass a range 26 in which the operation part indicator 23 is projected onto the second detection surface 3 in the normal direction. Further, it is assumed that, after the fingertip 13 of the operator has passed the second detection surface 3, a shift is likely to occur at speed of ±Vh at the fingertip 13 in the screen up-down direction. When the distance between the first detection surface 2 and the second detection surface 3 is represented as D, time T from the time when the fingertip 13 of the operator is detected in the range 26 on the second detection surface 3 until the time when the fingertip 13 comes into contact with the first detection surface 2 and is detected is represented by Expression (1). A maximum amount Lh of a distance that the fingertip 13 shifts in the time T is represented by Expression (2).

[Math 1]

T=D/V (1)

[Math 2]

Lₕ=Vₕ×T (2)

Therefore, even if the fingertip 13 is detected at an end of the range 26 on the second detection surface 3 and the fingertip 13 shifts to the maximum in a direction away from the operation part indicator 23 set as the target, when the interval between the operation part indicator 23 and another operation part indicator 24 adjacent thereto is represented as L, if Expression (3) is satisfied, the fingertip 13 does not come into contact with the first detection surface 2 in the position of the adjacent other operation part indicator 24.

[Math 3]

L>Lₕ (3)

When the fingertip 13 is detected in the center of the range 26, if height S (a distance in the up-down direction) on the screen of the operation part indicator 23 satisfies Expression (4), the operator does not fail in pressing the operation part indicator 23 on the first detection surface 2 in a normal operation.

[Math 4]

S/2>Lₕ (4)

By defining an appropriate time interval for the time T from the detection on the second detection surface 3 to the detection on the first detection surface 2 and not receiving an input when the time T deviates from the time interval, it is possible to prevent an accident in which a finger or another object comes into contact with the display surface when operation is unintended and an accident in which the operator repeatedly taps the display screen in a panic state or the like.

When the positional relation between the operation part indicators 23 and 24 and the first detection surface 2 and the second detection surface 3 is appropriate and the time T is appropriately defined, the fingertip 13 detected in the range 26 on the second detection surface 3 cannot press, on the first detection surface 2, the operation part indicator 24 other than the operation part indicator 23 set as the target. Therefore, the position detection of the fingertip 13 only has to be possible on the second detection surface 3. The first detection surface 2 only has to be capable of detecting that the fingertip 13 comes into contact with the first detection surface 2 even if a position is unknown. Consequently, it is possible to simplify processing concerning the first detection surface 2.

The touch panel configuring the first detection surface 2 is suitably a so-called contact-type touch panel such as a piezoelectric type, a resistance film type, an ultrasonic type, or a sensitivity-adjusted capacitance type because the operator can feel that the operator touches the touch panel. Further, if the method explained above is used, the position of the fingertip 13 can be specified only on the second detection surface 3. The first detection surface 2 only has to be capable of detecting that the fingertip 13 comes into contact with the first detection surface 2. Such a detection surface can be realized by providing a vibration detection sensor 27 in the vicinity of the image display surface 4 as shown in FIG. 3 and detecting vibration due to a shock at the time when the fingertip 13 comes into contact with the image display surface 4 or propagating sound or vibration. There are various methods for the vibration detection. However, a method of detecting vibration with an electromotive force by a permanent magnet and a coil as in a voice coil of a so-called microphone or speaker is inexpensive. In this case, the surface of the image display surface 4 is suitably a hard material because vibration easily occurs and propagates. On the other hand, since the fingertip 13 passes through the second detection surface 3, it is suitable to use a type called an infrared type or an optical type in which plane light or reflected light or blocking of light due to beam scan in a horizontal plane is used for detection, an image recognition system for picking up an image of a finger from a side, analyzing the image, and performing position detection, or the like.

### Second Embodiment

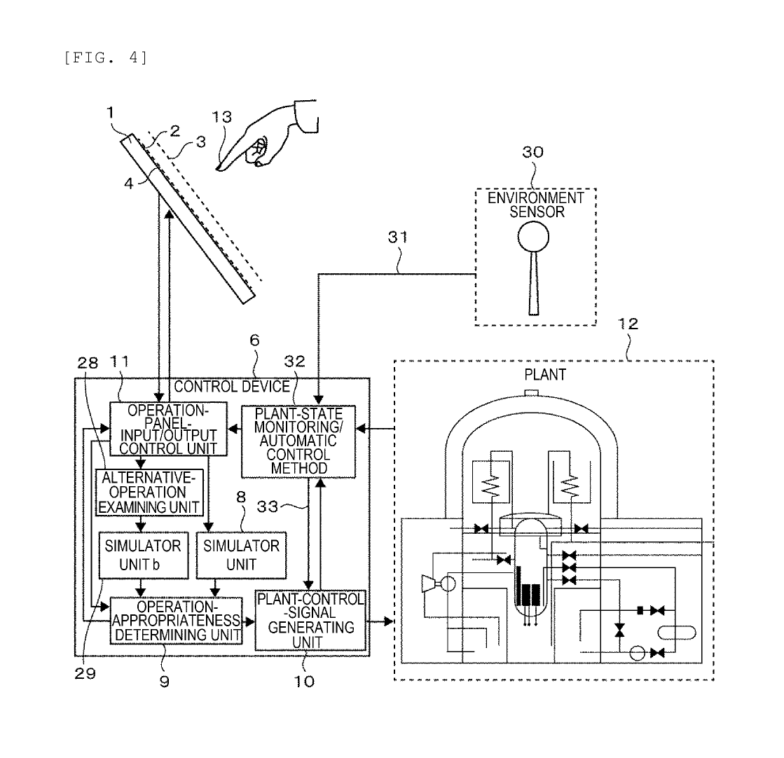

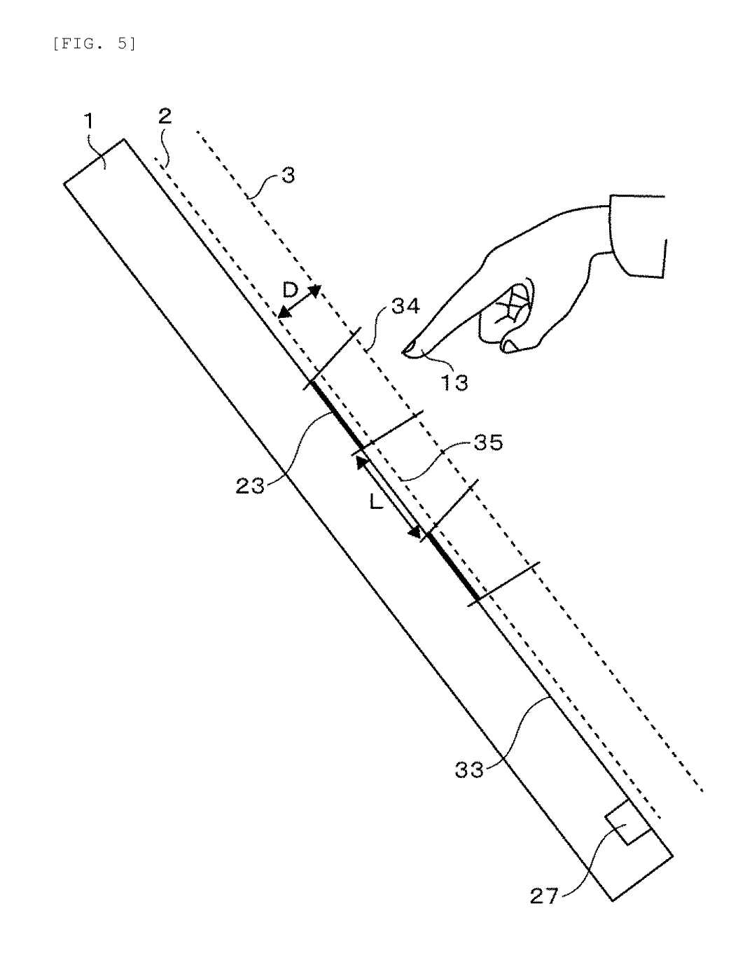

FIG. 4 is a schematic diagram showing another operation panel for operating a plant. FIG. 5 is a side view showing still another configuration example of the display with touch panel.

In this embodiment, components and functions are similar to those in the first embodiment. However, a part of the components and the functions are different. First, the plant-state monitoring unit 7 in the first embodiment is replaced with a plant-state monitoring/automatic control unit 32. An environment sensor signal 31 from an environment sensor is also input to the plant-state monitoring/automatic control unit 32. The environment sensor 30 is set outside the plant 12. The sensor signal 31 is, for example, the sensor signal 30 of any one or a plurality of temperature, a wind direction, wind velocity, a rainfall, seismic intensity, thunder information, and the like of a region of the plant 12 measured in the neighborhood of the plant 12 or by a meteorological radar or the like. The sensor signal 30 is input to the plant-state monitoring/automatic control unit 32 together with state data of the plant 12. The plant-state monitoring/automatic control unit 32 processes the input sensor signal 30 and the input state data and outputs the sensor signal 30 and the state data to the operation-panel-input/output control unit 11. Further, the plant-state monitoring/automatic control unit 32 distinguishes an event that has high emergency because of an accident due to fire, earthquake, or the like and for which a processing procedure is clear and directly outputs a signal 33 for requesting the plant-control-signal generating unit 10 to output an appropriate plant control signal. With such a configuration, concerning normal operation, processing in a procedure same as the procedure in the first embodiment is performed. However, concerning an event that requires emergency and for which corresponding operation is determined, it is possible to more quickly output the plant control signal to the plant 12 without waiting for the analysis by the simulator unit 8 and the determination in the operation-appropriateness determining unit 9.

Even when the simulator unit 8 predicts and analyzes, from the detection of the fingertip 13 on the second detection surface 3 on the display with touch panel 1 explained in the first embodiment, operation that the operator is about to perform and the operation-appropriateness determining unit 9 determines appropriateness, for example, when fire occurs in the neighborhood, it is possible to give more appropriate determination for, for example, not receiving transfer operation of a flammable substance in a direction close to a fire site.

Further, in the second embodiment, prediction data of the operation that the operator is about to perform is not only output from the operation-panel-input/output control unit 11 to the simulator unit 8 but also output to an alternative-operation examining unit 28. The alternative-operation examining unit 28 checks whether there is alternative operation registered in advance to correspond to operation intended by the operator and, when the alternative operation is present, outputs prediction data to a simulator unit b 29 to cause the simulator unit b 29 to predict and analyze a case in which the alternative operation is performed. When the operation intended by the operator predicted and analyzed by the simulator 8 is determined as inappropriate (No) by the operation-appropriateness determining unit 9, the operation-appropriateness determining unit 9 performs appropriateness determination of a prediction analysis result of the alternative operation by the simulator unit b 29. When it is determined that the prediction analysis result is appropriate, the operation-appropriateness determining unit 9 presents the alternative operation to the touch panel display 1 via the operation-panel-input/output unit 11 and, waiting for detection of the fingertip 13 of the operator on the first detection surface 2, outputs a signal for requesting an output of a plant control signal for the alternative operation to the plant-control-signal generating unit 10.

When it is determined that the result of the prediction analysis of the alternative operation is also determined as inappropriate, the operation-appropriateness determining unit 9 displays the alternative operation inappropriateness on the touch panel display 1 via the operation-panel-input/output unit 11. While the fingertip 13 of the operator points at the same operation part indicator, the operation-appropriateness determining unit 9 further determines whether alternative operation is present, when the alternative operation is present, performs a prediction analysis, determines appropriateness, and, when it is determined that a prediction analysis result is appropriate, outputs a signal for requesting an output of a plant control signal for the alternative operation to the plant-control-signal generating unit 10. When it is determined that the alternative operation is absent or all kinds of alternative operation are determined as inappropriate or when it is determined in the position detection on the second detection surface 3 that the fingertip 13 of the operator is away from the operation part indicator, the processing by the alternative-operation examining unit 28 based on the prediction data of the operation that the operator is about to perform ends.

The check of the alternative operation is, for example, when there are two systems of an A system for normal use and a B system for emergency as water supply systems to a certain tank, registering the systems as alternative systems each other and, when operation by the operator is water supply operation by the A system, selecting water supply operation by the B system as the alternative operation. If three systems including a C system is registered as alternative systems one another as water supply systems, which of water supply by the B system and water supply by the C system is selected as the alternative operation depends on a logic determined in advance. However, for example, when the plant-state monitoring/automatic control unit 32 determines from state data of the plant that the B system is inoperable, data indicating the inoperability of the B system is also sent to the alternative-operation examining unit 28. The water supply by the C system is selected as the alternative operation.

With such a configuration, it is possible to realize a plant control system in which, even when the operation intended by the operator is determined as inappropriate, alternative operation registered in advance is present and, if a prediction analysis result of the alternative operation is appropriate, the alternative operation is quickly executed.

A mechanism of the touch panel display 1 shown in FIG. 4 is explained with reference to FIG. 5. In this example, both of the first detection surface 2 and the second detection surface 3 are configured by a so-called projection capacitance-type touch panel in which a change in capacitance is used as the principle of detection of the fingertip 13. As the principle of a capacitance-type sensor, considering that a capacitor is formed between an electrode provided on the sensor side and a finger, a change in the capacity of the capacitor is detected. Therefore, if the sensitivity of the detection is high, it is possible to detect the fingertip 13 even if the fingertip 13 does not come into contact with the sensor. Further, by appropriately setting a capacity serving as a threshold, it is also possible to detect distances in two stages. One capacitance-type sensor can be used as a sensor including two detection surfaces of the first detection surface 2 and the second detection surface 3. The capacitance-type sensor is integrated with an image display surface 33 and is flat. Therefore, a convex structure around the image display surface for housing the sensor shown in FIG. 2 is unnecessary. The capacitance-type sensor can be flat and easily operated as the touch panel display 1.

In the capacitance-type sensor, it is likely that, because of the principle of the capacitance-type sensor, the capacity of the capacitor changes according to the size of the fingertip 13 and the detection distance changes. When the second detection surface 3 is set in a position sufficiently away from the image display surface 33, it is likely that the first detection surface 2 is also formed away from the image display surface 33 because, for example, the fingertip 13 is thick. To avoid this and surely detect that the fingertip 13 comes into contact with the image display surface 33, it is desirable to use the vibration detection sensor 27 as in the example shown in FIG. 3 and detect sound or vibration at the time when the fingertip 13 comes into contact with the image display surface 33 and use the sound and the vibration together with the change in the capacity.

As explained above, according to this embodiment, it is possible to eliminate or reduce stress for an operator who operates an operation panel.

### REFERENCE SIGNS LIST

1 Display with touch panel
2 First detection surface
3 Second detection surface
4 Image display surface
5 Space between the first detection surface and the second detection surface
6 Control device
7 Plant-state monitoring unit
8 Simulator unit
9 Operation-appropriateness determining unit
10 Plant-control-signal generating unit
11 Operation-panel-input/output control unit
12 Control target plant
13 Finger of an operator
14 Distance D between the first detection surface and the second detection surface
15 State data of a plant
16 Display image data signal
17 Detection signal from a touch panel
18 Detection signal on the first detection surface
19 Signal for requesting control signal transmission
20 Plant control signal
21 Communication signal
22 Operation rejection signal
23 Operation part indicator set as a contact target
24 Adjacent operation part indicator
25 Interval to the adjacent operation part indicator
26 Range in which the operation part indicator 23 is projected on the second detection surface in the normal direction
27 Vibration detection sensor
28 Alternative-operation examining unit
29 Simulator unit b
30 Environment sensor
31 External environment sensor signal
32 Plant-state monitoring/automatic control unit
33 Image display panel with capacitance-type sensor
34 Region determined as the operation part indicator set as a target on the second detection surface
35 Space between the surface of the image display surface and the first detection surface

1. A touch panel-type operation panel comprising:
a display with touch panel including an image display surface for displaying an operation part, the display with touch panel detecting approach of an operation finger to the operation part and a position of the operation part and outputting signals of the detected approach and the detected position; and
a control device that predicts and analyzes, in response to an input of the signals of the approach of the operation finger and the position, a state of a control target by operation corresponding to the operation part with reference to state data of the control target, determines appropriateness of the predicted and analyzed operation, and outputs a result of the determination.

2. The touch panel-type operation panel according to claim 1, wherein
the display with touch panel includes a first detection surface for detecting that the operation finger comes into contact with the image display surface and a second detection surface for detecting the approach of the operation finger to the operation part and the position of the operation part,
the signals of the approach and the position are approach of the operation finger to the operation part and a position of the operation part detected on the second detection surface, and
when the result of the determination of appropriateness of the operation is appropriate, the control device outputs a control signal corresponding to the operation to the control target in response to the detection of the operation finger on the first detection surface.

3. The touch panel-type operation panel according to claim 1, wherein the control device prepares alternative operation corresponding to the operation in advance, executes, in parallel to the prediction analysis of the state of the control target by the operation, a prediction analysis of the state of the control target by the alternative operation, and, when appropriateness of the predicted and analyzed alternative operation is determined as inappropriate, outputs a determination result of the appropriateness of the predicted and analyzed alternative operation.

4. The touch panel-type operation panel according to claim 1, wherein the control device is connected to an environment sensor set in a vicinity of the control target, distinguishes, on the basis of a signal from the environment sensor, an event of the control target that has high emergency and for which a processing procedure is clear, and outputs a control signal corresponding to a distinction result to the control target.

5. A control method of a control device of a touch panel-type operation panel to which a display with touch panel is connected,
the display with touch panel including an image display surface on which an operation part is displayed,
the control method comprising:
detecting approach of an operation finger to the operation part and a position of the operation part;
outputting signals of the detected approach and the detected position;
predicting and analyzing, in response to an input of the signals of the approach of the operation finger and the position, a state of a control target by operation corresponding to the operation part with reference to state data of the control target;
determining appropriateness of the predicted and analyzed operation; and
outputting a result of the determination.

6. The control method according to claim 5, wherein
the display with touch panel includes a first detection surface for detecting that the operation finger comes into contact with the image display surface and a second detection surface for detecting the approach of the operation finger to the operation part and the position of the operation part,
the display with touch panel detects, on the second detection surface, approach of the operation finger to the operation part and a position of the operation part and detects the operation finger on the first detection surface, and
when the result of the determination of appropriateness of the operation is appropriate, the control device outputs a control signal corresponding to the operation to the control target in response to the detection of the operation finger on the first detection surface.

7. The control method according to claim 5, wherein the control device prepares alternative operation corresponding to the operation in advance, executes, in parallel to the prediction analysis of the state of the control target by the operation, a prediction analysis of the state of the control target by the alternative operation, and, when appropriateness of the predicted and analyzed alternative operation is determined as inappropriate, outputs a determination result of the appropriateness of the predicted and analyzed alternative operation.

8. The control method according to claim 5, wherein the control device is connected to an environment sensor set in a vicinity of the control target, distinguishes, on the basis of a signal from the environment sensor, an event of the control target that has high emergency and for which a processing procedure is clear, and outputs a control signal corresponding to a distinction result to the control target.
